(19) United States
(12) Patent Application Publication
(10) Pub. No.: US 2023/0196595 A1
(43) Pub. Date: Jun. 22, 2023

(54) METHODS AND SYSTEMS FOR REGISTERING PREOPERATIVE IMAGE DATA TO INTRAOPERATIVE IMAGE DATA OF A SCENE, SUCH AS A SURGICAL SCENE

(71) Applicant: Proprio, Inc., Seattle, WA (US)

(72) Inventors: Robert Bruce Grupp, JR., Tacoma, WA (US); Samuel R. Browd, Mercer Island, WA (US); James Andrew Youngquist, Seattle, WA (US); Nava Aghdasi, Kirkland, WA (US); Theodores Lazarakis, Las Vegas, NV (US); Tze-Yuan Cheng, Bellevue, WA (US); Adam Gabriel Jones, Seattle, WA (US)

(21) Appl. No.: 18/084,389

(22) Filed: Dec. 19, 2022

Related U.S. Application Data
(60) Provisional application No. 63/291,906, filed on Dec. 20, 2021.

(51) Int. Cl. G06T 7/33; G06T 17/00; G06T 5/50; G06T 7/70; G06V 10/74; G06V 20/70

(52) U.S. Cl. CPC G06T 7/33; G06T 17/00; G06T 5/50; G06T 7/70; G06V 10/761; G06V 20/70; G06T 2207/10081; G06T 2207/20221; G06T 2207/30012

(57) ABSTRACT

Medical imaging systems, methods, and devices are disclosed herein. In some embodiments, an imaging system includes (i) a camera array configured to capture intraoperative image data of a surgical scene in substantially real-time and (ii) a processing device communicatively coupled to the camera array. The processing device can be configured to synthesize a three-dimensional (3D) image corresponding to a virtual perspective of the scene based on the intraoperative image data from the cameras. The imaging system is further configured to receive and/or store initial image data, such as medical scan data corresponding to a portion of a patient in the scene. The processing device can register the initial image data to the intraoperative image data, and overlay the registered initial image data over the corresponding portion of the 3D image of the scene to present a mediated-reality view.

### CROSS-REFERENCE TO RELATED APPLICATION

This application claims the benefit of U.S. Provisional Patent Application No. 63/291,906, filed on Dec. 20, 2021, and titled “METHODS AND SYSTEMS FOR REGISTERING PREOPERATIVE IMAGE DATA TO INTRAOPERATIVE IMAGE DATA OF A SCENE, SUCH AS A SURGICAL SCENE,” which is incorporated herein by reference in its entirety.

### TECHNICAL FIELD

The present technology generally relates to methods for generating a view of a scene, and registering initial image data, such as preoperative medical images (e.g., computed tomography (CT) scan data), to the scene.

### BACKGROUND

In a mediated-reality system, an image processing system adds, subtracts, and/or modifies visual information representing an environment. For surgical applications, a mediated-reality system may enable a surgeon to view a surgical site from a desired perspective together with contextual information that assists the surgeon in more efficiently and precisely performing surgical tasks. When performing surgeries, surgeons often rely on previously-captured or initial three-dimensional images of the patient's anatomy, such as computed tomography (CT) scan images. However, the usefulness of such initial images is limited because the images cannot be easily integrated into the operative procedure. For example, because the images are captured in a initial session, the relative anatomical positions captured in the initial images may vary from their actual positions during the operative procedure. Furthermore, to make use of the initial images during the surgery, the surgeon must divide their attention between the surgical field and a display of the initial images. Navigating between different layers of the initial images may also require significant attention that takes away from the surgeon's focus on the operation.

### BRIEF DESCRIPTION OF THE DRAWINGS

Many aspects of the present disclosure can be better understood with reference to the following drawings. The components in the drawings are not necessarily to scale. Instead, emphasis is placed on clearly illustrating the principles of the present disclosure.

FIG. 1 is a schematic view of an imaging system in accordance with embodiments of the present technology.

FIG. 2 is a perspective view of a surgical environment employing the imaging system of FIG. 1 for a surgical application in accordance with embodiments of the present technology.

FIG. 3 is an isometric view of a portion of the imaging system of FIG. 1 illustrating four cameras of the imaging system in accordance with embodiments of the present technology.

FIG. 4 is a flow diagram of a process or method for registering initial image data to intraoperative image data in accordance with embodiments of the present technology.

FIGS. 5A-5C are schematic illustrations of intraoperative image data of an object within the field of view of a camera array and corresponding initial image data of the object illustrating various stages in accordance with embodiments of the present technology.

FIG. 6 is a flow diagram of a process or method for registering initial image data to intraoperative image data in accordance with additional embodiments of the present technology.

FIG. 7 is a flow diagram of a process or method for registering initial image data to intraoperative image data in accordance with additional embodiments of the present technology.

FIG. 8 is a flow diagram of a process or method for registering initial image data to intraoperative image data in accordance with additional embodiments of the present technology.

FIG. 9 is a flow diagram of a process or method for refining the registration of initial image data to intraoperative image data in accordance with embodiments of the present technology.

FIG. 10 is a flow diagram of a process or method for registering initial image data to intraoperative image data in accordance with additional embodiments of the present technology.

FIG. 11 is a flow diagram of a process or method for registering initial image data to intraoperative image data in accordance with additional embodiments of the present technology.

### DETAILED DESCRIPTION

Aspects of the present technology are directed generally to imaging systems, such as for use in imaging surgical procedures, and associated methods for registering initial image data to intraoperative image data for display together. In several of the embodiments described below, for example, an imaging system includes (i) a camera array that can capture intraoperative image data (e.g., RGB data, infrared data, hyper-spectral data, light field data, and/or depth data) of a surgical scene and (ii) a processing device communicatively coupled to the camera array. The processing device can synthesize/generate a three-dimensional (3D) virtual image corresponding to a virtual perspective of the scene in real-time or near-real-time based on the image data from at least a subset of the cameras. The processing device can output the 3D virtual image to a display device (e.g., a head-mounted display (HMD) and/or a surgical monitor) for viewing by a viewer, such as a surgeon or other operator of the imaging system. The imaging system can also receive and/or store initial image data (which can also be referred to as previously-captured image data). The initial image data can be medical scan data (e.g., computerized tomography (CT) scan data) corresponding to a portion of a patient in the scene, such as a spine of a patient undergoing a spinal surgical procedure.

The processing device can register the initial image data to the intraoperative image data by, for example, registering/matching fiducial markers and/or other feature points visible in 3D data sets representing both the initial and interoperative image data. The processing device can further apply a transform to the initial image data based on the registration to, for example, substantially align (e.g., in a common coordinate frame) the initial image data with the real-time or near-real-time intraoperative image data captured with the camera array and/or generated by the processing device (e.g., based on image data captured with the camera array). The processing device can then display the initial image data and the intraoperative image data together (e.g., on a surgical monitor and/or HMD) to provide a mediated-reality view of the surgical scene. More specifically, the processing device can overlay a 3D graphical representation of the initial image data over a corresponding portion of the 3D virtual image of the scene to present the mediated-reality view that enables, for example, a surgeon to simultaneously view a surgical site in the scene and the underlying 3D anatomy of the patient undergoing the operation. In some aspects of the present technology, viewing the initial image data overlaid over (e.g., superimposed on, spatially aligned with) the surgical site provides the surgeon with “volumetric intelligence” by allowing them to, for example, visualize aspects of the surgical site that are obscured in the physical scene.

In some embodiments, the processing device of the imaging system can implement a method for registering the initial image data, such as medical scan data, to the intraoperative data that includes initially registering a single target vertebra in the initial image data to the same target vertebra in the intraoperative data. The method can further include estimating a pose of at least one other vertebra adjacent to the registered target vertebra, and comparing a pose of the at least one other vertebra in the intraoperative data to the estimated pose of the at least one other vertebra to compute a registration metric. If the registration metric is less than a threshold tolerance, the method can include retaining the registration of the target vertebra in the initial image data to the target vertebra in the intraoperative data. And, if the registration metric is greater than the threshold tolerance, the method can include identifying the registration of the target vertebra in the initial image data to the target vertebra in the intraoperative data as an ill-registration and/or restarting the registration procedure.

In some embodiments, the processing device of the imaging system can additionally or alternatively implement a method for registering the initial image data to the intraoperative image data that includes generating a 3D surface reconstruction of a portion of a patient based on the intraoperative data, and labeling individual points in the 3D surface reconstruction with a label based on the intraoperative data. For example, light field data and/or other image data captured by the camera array can be used to label the points as “bone” or “soft tissue.” The method can further include registering the initial image data to the intraoperative data based at least in part on the labels and a set of rules.

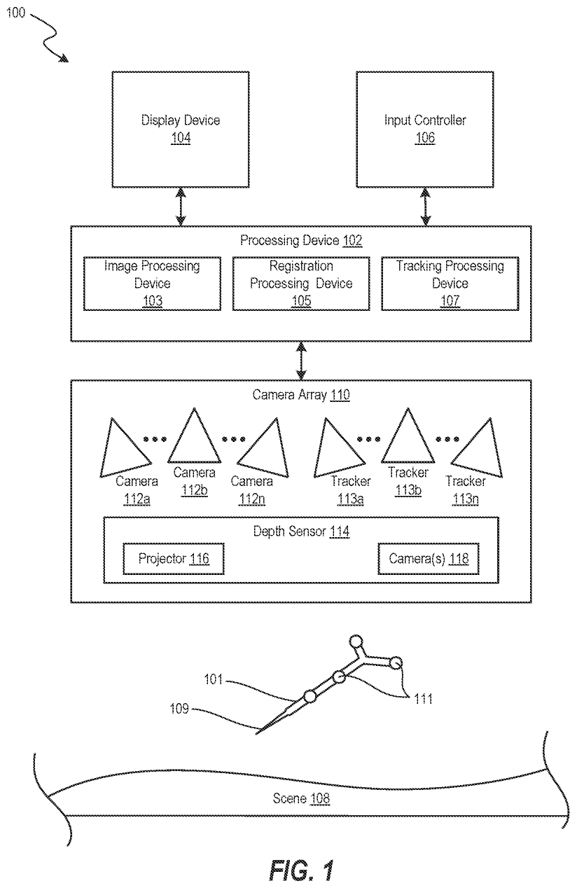

Specific details of several embodiments of the present technology are described herein with reference to FIGS. 1-11. The present technology, however, can be practiced without some of these specific details. In some instances, well-known structures and techniques often associated with camera arrays, light field imaging, image reconstruction, registration processes, and the like have not been shown in detail so as not to obscure the present technology.

The terminology used in the description presented below is intended to be interpreted in its broadest reasonable manner, even though it is being used in conjunction with a detailed description of certain specific embodiments of the disclosure. Certain terms can even be emphasized below; however, any terminology intended to be interpreted in any restricted manner will be overtly and specifically defined as such in this Detailed Description section.

Moreover, although frequently described in the context of registering initial image data to intraoperative image data of a surgical scene, and more particularly a spinal surgical scene, the registrations techniques of the present technology can be used to register data of other types. For example, the systems and methods of the present technology can be used more generally to register any previously-captured data to corresponding real-time or near-real-time image data of a scene to generate a mediated reality view of the scene including a combination/fusion of the previously-captured data and the real-time images.

The accompanying Figures depict embodiments of the present technology and are not intended to be limiting of its scope. Depicted elements are not necessarily drawn to scale, and various elements can be arbitrarily enlarged to improve legibility. Component details can be abstracted in the figures to exclude details as such details are unnecessary for a complete understanding of how to make and use the present technology. Many of the details, dimensions, angles, and other features shown in the Figures are merely illustrative of particular embodiments of the disclosure. Accordingly, other embodiments can have other dimensions, angles, and features without departing from the spirit or scope of the present technology.

The headings provided herein are for convenience only and should not be construed as limiting the subject matter disclosed. To the extent any materials incorporated herein by reference conflict with the present disclosure, the present disclosure controls.

### I. SELECTED EMBODIMENTS OF IMAGING SYSTEMS

FIG. 1 is a schematic view of an imaging system 100 (“system 100”) in accordance with embodiments of the present technology. In some embodiments, the system 100 can be a synthetic augmented reality system, a virtual-reality imaging system, an augmented-reality imaging system, a mediated-reality imaging system, and/or a non-immersive computational imaging system. In the illustrated embodiment, the system 100 includes a processing device 102 that is communicatively coupled to one or more display devices 104, one or more input controllers 106, and a camera array 110. In other embodiments, the system 100 can comprise additional, fewer, or different components. In some embodiments, the system 100 includes some features that are generally similar or identical to those of the mediated-reality imaging systems disclosed in (i) U.S. patent application Ser. No. 16/586,375, titled “CAMERA ARRAY FOR A MEDIATED-REALITY SYSTEM,” and filed Sep. 27, 2019 and/or (ii) U.S. patent application Ser. No. 15/930,305, titled “METHODS AND SYSTEMS FOR IMAGING A SCENE, SUCH AS A MEDICAL SCENE, AND TRACKING OBJECTS WITHIN THE SCENE,” and filed May 12, 2020, each of which is incorporated herein by reference in its entirety.

In the illustrated embodiment, the camera array 110 includes a plurality of cameras 112 (identified individually as cameras 112a-112n; which can also be referred to as first cameras) that can each capture images of a scene 108 (e.g., first image data) from a different perspective. The scene 108 can include for example, a patient undergoing surgery (e.g., spinal surgery) and/or another medical procedure. In other embodiments, the scene 108 can be another type of scene. The camera array 110 can further include dedicated object tracking hardware 113 (e.g., including individually identified trackers 113a-113n) that captures positional data of one more objects, such as an instrument 101 (e.g., a surgical instrument or tool) having a tip 109, to track the movement and/or orientation of the objects through/in the scene 108. In some embodiments, the cameras 112 and the trackers 113 are positioned at fixed locations and orientations (e.g., poses) relative to one another. For example, the cameras 112 and the trackers 113 can be structurally secured by/to a mounting structure (e.g., a frame) at predefined fixed locations and orientations. In some embodiments, the cameras 112 are positioned such that neighboring cameras 112 share overlapping views of the scene 108. In general, the position of the cameras 112 can be selected to maximize clear and accurate capture of all or a selected portion of the scene 108. Likewise, the trackers 113 can be positioned such that neighboring trackers 113 share overlapping views of the scene 108. Therefore, all or a subset of the cameras 112 and the trackers 113 can have different extrinsic parameters, such as position and orientation.

In some embodiments, the cameras 112 in the camera array 110 are synchronized to capture images of the scene 108 simultaneously (within a threshold temporal error). In some embodiments, all or a subset of the cameras 112 are light field, plenoptic, and/or RGB cameras that capture information about the light field emanating from the scene 108 (e.g., information about the intensity of light rays in the scene 108 and also information about a direction the light rays are traveling through space). In some embodiments, image data from the cameras 112 can be used to reconstruct a light field of the scene 108. Therefore, in some embodiments the images captured by the cameras 112 encode depth information representing a surface geometry of the scene 108. In some embodiments, the cameras 112 are substantially identical. In other embodiments, the cameras 112 include multiple cameras of different types. For example, different subsets of the cameras 112 can have different intrinsic parameters such as focal length, sensor type, optical components, and the like. The cameras 112 can have charge-coupled device (CCD) and/or complementary metal-oxide semiconductor (CMOS) image sensors and associated optics. Such optics can include a variety of configurations including lensed or bare individual image sensors in combination with larger macro lenses, micro-lens arrays, prisms, and/or negative lenses. For example, the cameras 112 can be separate light field cameras each having their own image sensors and optics. In other embodiments, some or all of the cameras 112 can comprise separate microlenslets (e.g., lenslets, lenses, microlenses) of a microlens array (MLA) that share a common image sensor. In other embodiments, some or all of the cameras 112 can be RGB (e.g., color) cameras having visible imaging sensors.

In some embodiments, the trackers 113 are imaging devices, such as infrared (IR) cameras that can capture images of the scene 108 from a different perspective compared to other ones of the trackers 113. Accordingly, the trackers 113 and the cameras 112 can have different spectral sensitives (e.g., infrared vs. visible wavelength). In some embodiments, the trackers 113 capture image data of a plurality of optical markers (e.g., fiducial markers, marker balls) in the scene 108, such as markers 111 coupled to the instrument 101.

In the illustrated embodiment, the camera array 110 further includes a depth sensor 114. In some embodiments, the depth sensor 114 includes (i) one or more projectors 116 that project a structured light pattern onto/into the scene 108 and (ii) one or more depth cameras 118 (which can also be referred to as second cameras) that capture second image data of the scene 108 including the structured light projected onto the scene 108 by the projector 116. The projector 116 and the depth cameras 118 can operate in the same wavelength and, in some embodiments, can operate in a wavelength different than the cameras 112. For example, the cameras 112 can capture the first image data in the visible spectrum, while the depth cameras 118 capture the second image data in the infrared spectrum. In some embodiments, the depth cameras 118 have a resolution that is less than a resolution of the cameras 112. For example, the depth cameras 118 can have a resolution that is less than 70%, 60%, 50%, 40%, 30%, or 20% of the resolution of the cameras 112. In other embodiments, the depth sensor 114 can include other types of dedicated depth detection hardware (e.g., a LiDAR detector) for determining the surface geometry of the scene 108. In other embodiments, the camera array 110 can omit the projector 116 and/or the depth cameras 118.

In the illustrated embodiment, the processing device 102 includes an image processing device 103 (e.g., an image processor, an image processing module, an image processing unit), a registration processing device 105 (e.g., a registration processor, a registration processing module, a registration processing unit), and a tracking processing device 107 (e.g., a tracking processor, a tracking processing module, a tracking processing unit). The image processing device 103 can (i) receive the first image data captured by the cameras 112 (e.g., light field images, light field image data, RGB images) and depth information from the depth sensor 114 (e.g., the second image data captured by the depth cameras 118), and (ii) process the image data and depth information to synthesize (e.g., generate, reconstruct, render) a three-dimensional (3D) output image of the scene 108 corresponding to a virtual camera perspective. The output image can correspond to an approximation of an image of the scene 108 that would be captured by a camera placed at an arbitrary position and orientation corresponding to the virtual camera perspective. In some embodiments, the image processing device 103 can further receive and/or store calibration data for the cameras 112 and/or the depth cameras 118 and synthesize the output image based on the image data, the depth information, and/or the calibration data. More specifically, the depth information and the calibration data can be used/combined with the images from the cameras 112 to synthesize the output image as a 3D (or stereoscopic 2D) rendering of the scene 108 as viewed from the virtual camera perspective. In some embodiments, the image processing device 103 can synthesize the output image using any of the methods disclosed in U.S. patent application Ser. No. 16/457,780, titled “SYNTHESIZING AN IMAGE FROM A VIRTUAL PERSPECTIVE USING PIXELS FROM A PHYSICAL IMAGER ARRAY WEIGHTED BASED ON DEPTH ERROR SENSITIVITY,” and filed Jun. 28, 2019, which is incorporated herein by reference in its entirety. In other embodiments, the image processing device 103 can generate the virtual camera perspective based only on the images captured by the cameras 112—without utilizing depth information from the depth sensor 114. For example, the image processing device 103 can generate the virtual camera perspective by interpolating between the different images captured by one or more of the cameras 112.

The image processing device 103 can synthesize the output image from images captured by a subset (e.g., two or more) of the cameras 112 in the camera array 110, and does not necessarily utilize images from all of the cameras 112. For example, for a given virtual camera perspective, the processing device 102 can select a stereoscopic pair of images from two of the cameras 112. In some embodiments, such a stereoscopic pair can be selected to be positioned and oriented to most closely match the virtual camera perspective. In some embodiments, the image processing device 103 (and/or the depth sensor 114) estimates a depth for each surface point of the scene 108 relative to a common origin to generate a point cloud and/or a 3D mesh that represents the surface geometry of the scene 108. Such a representation of the surface geometry can be referred to as a surface reconstruction, a 3D reconstruction, a 3D volume reconstruction, a volume reconstruction, a 3D surface reconstruction, a depth map, a depth surface, and/or the like. In some embodiments, the depth cameras 118 of the depth sensor 114 detect the structured light projected onto the scene 108 by the projector 116 to estimate depth information of the scene 108. In some embodiments, the image processing device 103 estimates depth from multiview image data from the cameras 112 using techniques such as light field correspondence, stereo block matching, photometric symmetry, correspondence, defocus, block matching, texture-assisted block matching, structured light, and the like, with or without utilizing information collected by the depth sensor 114. In other embodiments, depth may be acquired by a specialized set of the cameras 112 performing the aforementioned methods in another wavelength.

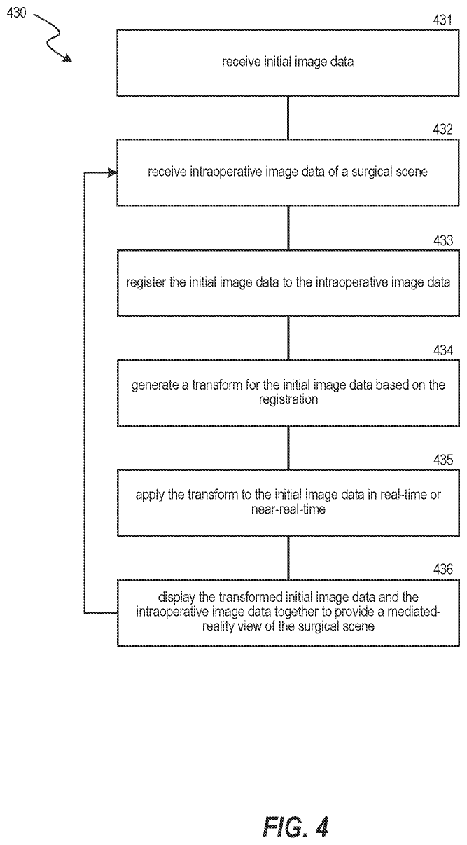

In some embodiments, the registration processing device 105 receives and/or stores initial image data, such as image data of a three-dimensional volume of a patient (3D image data). The image data can include, for example, computerized tomography (CT) scan data, magnetic resonance imaging (MM) scan data, ultrasound images, fluoroscope images, and/or other medical or other image data. The registration processing device 105 can register the initial image data to the real-time images captured by the cameras 112 and/or the depth sensor 114 by, for example, determining one or more transforms/transformations/mappings between the two. The processing device 102 (e.g., the image processing device 103) can then apply the one or more transforms to the initial image data such that the initial image data can be aligned with (e.g., overlaid on) the output image of the scene 108 in real-time or near real time on a frame-by-frame basis, even as the virtual perspective changes. That is, the image processing device 103 can fuse the initial image data with the real-time output image of the scene 108 to present a mediated-reality view that enables, for example, a surgeon to simultaneously view a surgical site in the scene 108 and the underlying 3D anatomy of a patient undergoing an operation. In some embodiments, the registration processing device 105 can register the initial image data to the real-time images by using any of the methods described in detail below with reference to FIGS. 4-11 and/or using any of the methods disclosed in U.S. patent application Ser. No. 17/140,885, titled “METHODS AND SYSTEMS FOR REGISTERING PREOPERATIVE IMAGE DATA TO INTRAOPERATIVE IMAGE DATA OF A SCENE, SUCH AS A SURGICAL SCENE,” and filed Jan. 4, 2021.

In some embodiments, the tracking processing device 107 processes positional data captured by the trackers 113 to track objects (e.g., the instrument 101) within the vicinity of the scene 108. For example, the tracking processing device 107 can determine the position of the markers 111 in the 2D images captured by two or more of the trackers 113, and can compute the 3D position of the markers 111 via triangulation of the 2D positional data. More specifically, in some embodiments the trackers 113 include dedicated processing hardware for determining positional data from captured images, such as a centroid of the markers 111 in the captured images. The trackers 113 can then transmit the positional data to the tracking processing device 107 for determining the 3D position of the markers 111. In other embodiments, the tracking processing device 107 can receive the raw image data from the trackers 113. In a surgical application, for example, the tracked object can comprise a surgical instrument, an implant, a hand or arm of a physician or assistant, and/or another object having the markers 111 mounted thereto. In some embodiments, the processing device 102 can recognize the tracked object as being separate from the scene 108, and can apply a visual effect to the 3D output image to distinguish the tracked object by, for example, highlighting the object, labeling the object, and/or applying a transparency to the object.

In some embodiments, functions attributed to the processing device 102, the image processing device 103, the registration processing device 105, and/or the tracking processing device 107 can be practically implemented by two or more physical devices. For example, in some embodiments a synchronization controller (not shown) controls images displayed by the projector 116 and sends synchronization signals to the cameras 112 to ensure synchronization between the cameras 112 and the projector 116 to enable fast, multi-frame, multicamera structured light scans. Additionally, such a synchronization controller can operate as a parameter server that stores hardware specific configurations such as parameters of the structured light scan, camera settings, and camera calibration data specific to the camera configuration of the camera array 110. The synchronization controller can be implemented in a separate physical device from a display controller that controls the display device 104, or the devices can be integrated together.

The processing device 102 can comprise a processor and a non-transitory computer-readable storage medium that stores instructions that when executed by the processor, carry out the functions attributed to the processing device 102 as described herein. Although not required, aspects and embodiments of the present technology can be described in the general context of computer-executable instructions, such as routines executed by a general-purpose computer, e.g., a server or personal computer. Those skilled in the relevant art will appreciate that the present technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The present technology can be embodied in a special purpose computer or data processor that is specifically programmed, configured or constructed to perform one or more of the computer-executable instructions explained in detail below. Indeed, the term “computer” (and like terms), as used generally herein, refers to any of the above devices, as well as any data processor or any device capable of communicating with a network, including consumer electronic goods such as game devices, cameras, or other electronic devices having a processor and other components, e.g., network communication circuitry.

The present technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines can be located in both local and remote memory storage devices. Aspects of the present technology described below can be stored or distributed on computer-readable media, including magnetic and optically readable and removable computer discs, stored as in chips (e.g., EEPROM or flash memory chips). Alternatively, aspects of the present technology can be distributed electronically over the Internet or over other networks (including wireless networks). Those skilled in the relevant art will recognize that portions of the present technology can reside on a server computer, while corresponding portions reside on a client computer. Data structures and transmission of data particular to aspects of the present technology are also encompassed within the scope of the present technology.

The virtual camera perspective is controlled by an input controller 106 that can update the virtual camera perspective based on user driven changes to the camera's position and rotation. The output images corresponding to the virtual camera perspective can be outputted to the display device 104. In some embodiments, the image processing device 103 can vary the perspective, the depth of field (e.g., aperture), the focus plane, and/or another parameter of the virtual camera (e.g., based on an input from the input controller) to generate different 3D output images without physically moving the camera array 110. The display device 104 can receive output images (e.g., the synthesized 3D rendering of the scene 108) and display the output images for viewing by one or more viewers. In some embodiments, the processing device 102 receives and processes inputs from the input controller 106 and processes the captured images from the camera array 110 to generate output images corresponding to the virtual perspective in substantially real-time or near real-time as perceived by a viewer of the display device 104 (e.g., at least as fast as the frame rate of the camera array 110).

Additionally, the display device 104 can display a graphical representation on/in the image of the virtual perspective of any (i) tracked objects within the scene 108 (e.g., a surgical instrument) and/or (ii) registered or unregistered initial image data. That is, for example, the system 100 (e.g., via the display device 104) can blend augmented data into the scene 108 by overlaying and aligning information on top of “passthrough” images of the scene 108 captured by the cameras 112. Moreover, the system 100 can create a mediated-reality experience where the scene 108 is reconstructed using light field image data of the scene 108 captured by the cameras 112, and where instruments are virtually represented in the reconstructed scene via information from the trackers 113. Additionally or alternatively, the system 100 can remove the original scene 108 and completely replace it with a registered and representative arrangement of the initially captured image data, thereby removing information in the scene 108 that is not pertinent to a user's task.

The display device 104 can comprise, for example, a head-mounted display device, a monitor, a computer display, and/or another display device. In some embodiments, the input controller 106 and the display device 104 are integrated into a head-mounted display device and the input controller 106 comprises a motion sensor that detects position and orientation of the head-mounted display device. In some embodiments, the system 100 can further include a separate tracking system (not shown), such an optical tracking system, for tracking the display device 104, the instrument 101, and/or other components within the scene 108. Such a tracking system can detect a position of the head-mounted display device 104 and input the position to the input controller 106. The virtual camera perspective can then be derived to correspond to the position and orientation of the head-mounted display device 104 in the same reference frame and at the calculated depth (e.g., as calculated by the depth sensor 114) such that the virtual perspective corresponds to a perspective that would be seen by a viewer wearing the head-mounted display device 104. Thus, in such embodiments the head-mounted display device 104 can provide a real-time rendering of the scene 108 as it would be seen by an observer without the head-mounted display device 104. Alternatively, the input controller 106 can comprise a user-controlled control device (e.g., a mouse, pointing device, handheld controller, gesture recognition controller) that enables a viewer to manually control the virtual perspective displayed by the display device 104.

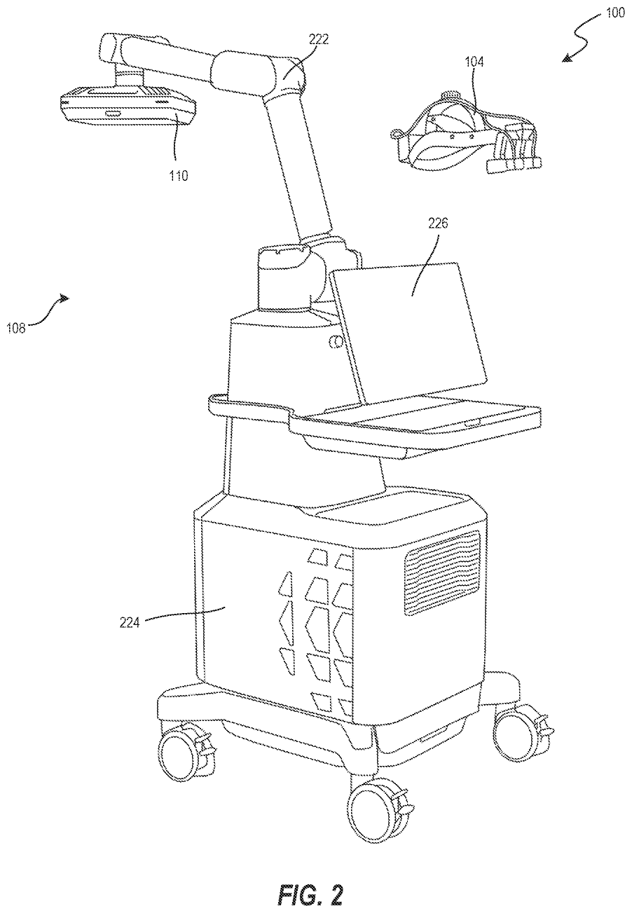

FIG. 2 is a perspective view of a surgical environment employing the system 100 for a surgical application in accordance with embodiments of the present technology. In the illustrated embodiment, the camera array 110 is positioned over the scene 108 (e.g., a surgical site) and supported/positioned via a movable arm 222 that is operably coupled to a workstation 224. In some embodiments, the arm 222 is manually movable to position the camera array 110 while, in other embodiments, the arm 222 is robotically controlled in response to the input controller 106 (FIG. 1) and/or another controller. In the illustrated embodiment, the display device 104 is a head-mounted display device (e.g., a virtual reality headset, augmented reality headset). The workstation 224 can include a computer to control various functions of the processing device 102, the display device 104, the input controller 106, the camera array 110, and/or other components of the system 100 shown in FIG. 1. Accordingly, in some embodiments the processing device 102 and the input controller 106 are each integrated in the workstation 224. In some embodiments, the workstation 224 includes a secondary display 226 that can display a user interface for performing various configuration functions, a mirrored image of the display on the display device 104, and/or other useful visual images/indications. In other embodiments, the system 100 can include more or fewer display devices. For example, in addition to the display device 104 and the secondary display 226, the system 100 can include another display (e.g., a medical grade computer monitor) visible to the user wearing the display device 104.

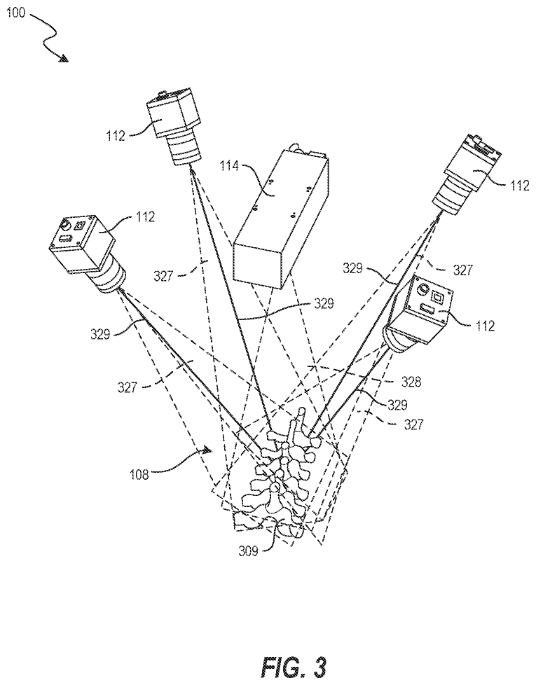

FIG. 3 is an isometric view of a portion of the system 100 illustrating four of the cameras 112 in accordance with embodiments of the present technology. Other components of the system 100 (e.g., other portions of the camera array 110, the processing device 102, etc.) are not shown in FIG. 3 for the sake of clarity. In the illustrated embodiment, each of the cameras 112 has a field of view 327 and a focal axis 329. Likewise, the depth sensor 114 can have a field of view 328 aligned with a portion of the scene 108. The cameras 112 can be oriented such that the fields of view 327 are aligned with a portion of the scene 108 and at least partially overlap one another to together define an imaging volume. In some embodiments, some or all of the field of views 327, 328 at least partially overlap. For example, in the illustrated embodiment the fields of view 327, 328 converge toward a common measurement volume including a portion of a spine 309 of a patient (e.g., a human patient) located in/at the scene 108. In some embodiments, the cameras 112 are further oriented such that the focal axes 329 converge to a common point in the scene 108. In some aspects of the present technology, the convergence/alignment of the focal axes 329 can generally maximize disparity measurements between the cameras 112. In some embodiments, the cameras 112 and the depth sensor 114 are fixedly positioned relative to one another (e.g., rigidly mounted to a common frame) such that a relative positioning of the cameras 112 and the depth sensor 114 relative to one another is known and/or can be readily determined via a calibration process. In other embodiments, the system 100 can include a different number of the cameras 112 and/or the cameras 112 can be positioned differently relative to another.

Referring to FIGS. 1-3 together, in some aspects of the present technology the system 100 can generate a digitized view of the scene 108 that provides a user (e.g., a surgeon) with increased “volumetric intelligence” of the scene 108. For example, the digitized scene 108 can be presented to the user from the perspective, orientation, and/or viewpoint of their eyes such that they effectively view the scene 108 as though they were not viewing the digitized image (e.g., as though they were not wearing the head-mounted display 104). However, the digitized scene 108 permits the user to digitally rotate, zoom, crop, or otherwise enhance their view to, for example, facilitate a surgical workflow. Likewise, initial image data, such as CT scans, can be registered to and overlaid over the image of the scene 108 to allow a surgeon to view these data sets together. Such a fused view can allow the surgeon to visualize aspects of a surgical site that may be obscured in the physical scene 108—such as regions of bone and/or tissue that have not been surgically exposed.

### II. SELECTED EMBODIMENTS OF REGISTRATION TECHNIQUES

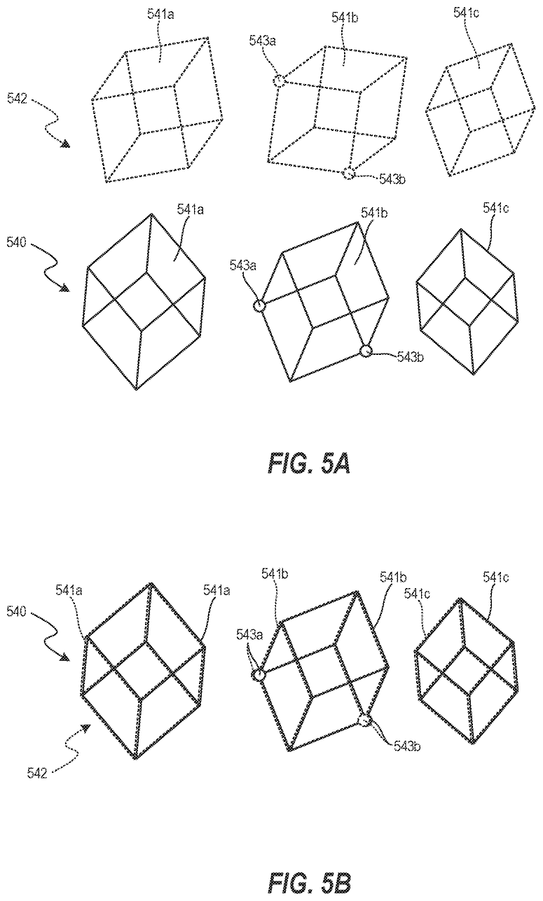

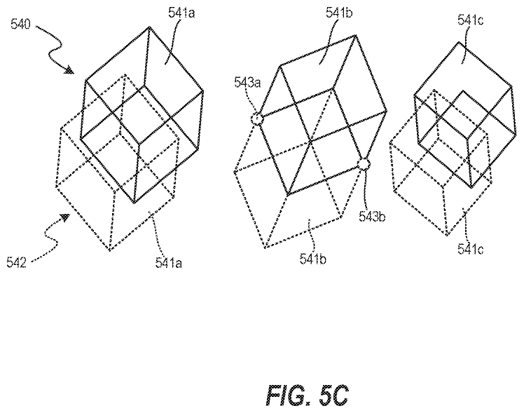

FIG. 4 is a flow diagram of a process or method 430 for registering initial image data to/with intraoperative image data to, for example, generate a mediated-reality view of a surgical scene in accordance with embodiments of the present technology. Although some features of the method 430 are described in the context of the system 100 shown in FIGS. 1-3 for the sake of illustration, one skilled in the art will readily understand that the method 430 can be carried out using other suitable systems and/or devices described herein. Similarly, while reference is made herein to initial image data, intraoperative image data, and a surgical scene, the method 430 can be used to register and display other types of information about other scenes. For example, the method 430 can be used more generally to register any previously-captured image data to corresponding real-time or near-real-time image data of a scene to generate a mediated-reality view of the scene including a combination/fusion of the previously-captured image data and the real-time images. FIGS. 5A-5C are schematic illustrations of intraoperative image data 540 of a spine (or other object) within the field of view of the camera array 110 and corresponding initial image data 542 of the spine (or other object) illustrating various stages of the method 430 of FIG. 4 in accordance with embodiments of the present technology. Accordingly, some aspects of the method 430 are described in the context of FIGS. 5A-5C.

At block 431, the method 430 can include receiving initial image data. As described in detail above, the initial image data can be, for example, medical scan data representing a three-dimensional volume of a patient, such as computerized tomography (CT) scan data, magnetic resonance imaging (MM) scan data, ultrasound images, fluoroscopic images, 3D reconstruction of 2D X-Ray images, and/or the like. In some embodiments, the initial image data comprises a point cloud, three-dimensional (3D) mesh, and/or another 3D data set. In some embodiments, the initial image data comprises segmented 3D CT scan data of, for example, some or all of a spine of a human patient. For example, in FIGS. 5A-5C the initial image data 542 includes data about a plurality of vertebrae 541 (identified individually as first through third vertebrae 541a-541c, respectively).

At block 432, the method 430 can include receiving intraoperative image data of the surgical scene 108 from the camera array 110. The intraoperative image data can include real-time or near-real-time images of a patient in the scene 108 captured by the cameras 112 and/or the depth cameras 118. In some embodiments, the intraoperative image data includes (i) light field images from the cameras 112 and (ii) images from the depth cameras 118 that include encoded depth information about the scene 108. In some embodiments, the initial image data corresponds to at least some features in the intraoperative image data. For example, the scene 108 can include a patient undergoing spinal surgery with their spine at least partially exposed (e.g., during a minimally invasive (MIS) or invasive procedure) such that the intraoperative image data includes images of the spine. More particularly, for example, in FIGS. 5A-5C the intraoperative image data 540 includes data about the same vertebrae 541 represented in the initial image data 542. Accordingly, various vertebrae or other features in the initial image data can correspond to portions of the patient's spine represented in the image data from the cameras 112, 118. In other embodiments, the scene 108 can include a patient undergoing another type of surgery, such as knee surgery, skull-based surgery, and so on, and the initial image data can include CT or other scan data of ligaments, nerves, bones, tissue, skin, and/or other anatomy relevant to the particular surgical procedure.

Referring to FIG. 5A, the initial image data 542 and the intraoperative image data 540 initially exist in different coordinate systems such that the same features in both data sets (e.g., the vertebrae 541) are represented differently. In the illustrated embodiment, for example, each of the vertebrae 541 in the initial image data 542 is rotated, scaled, and/or translated relative to the corresponding one of the vertebrae 541 in the intraoperative image data 540 of the spine.

Accordingly, at block 433, the method 430 includes registering the initial image data to the intraoperative image data to, for example, establish a transform/mapping/transformation between the intraoperative image data and the initial image data such that these data sets can be represented in the same coordinate system and subsequently displayed together. In some embodiments, the registration process matches (i) 3D points in a point cloud or a 3D mesh representing the initial image data to (ii) 3D points in a point cloud or a 3D mesh representing the intraoperative image data. In some embodiments, the system 100 (e.g., the registration processing device 105) can generate a 3D point cloud or mesh from the intraoperative image data from the depth cameras 118 of the depth sensor 114, and can register the point cloud or mesh to the initial image data by detecting positions of fiducial markers and/or feature points visible in both data sets. For example, where the initial image data comprises CT scan data, rigid bodies of bone surface calculated from the CT scan data can be registered to the corresponding points/surfaces of the point cloud or mesh.

More particularly, FIG. 5B shows the initial image data 542 registered to the intraoperative image data 540 based on the identification of a corresponding first point 543a and a corresponding second point 543b in both data sets (also shown in FIG. 5A for clarity). In some embodiments, the points 543a-b are points on the same target vertebra (e.g., the second vertebra 541b) exposed during a spinal surgical procedure. A surgeon or other user can identify the points 543a-b in the intraoperative image data 540 by touching a tracked instrument to the patient (e.g., to the second vertebra 541b). In some embodiments, the points 543a-b in the initial image data 542 correspond to screw entry points identified by a preoperative plan. In the illustrated embodiment, there are only two identified points 543a-b while, in other embodiments, the number of points 543a-b can be more or fewer.

In other embodiments, the system 100 can employ other registration processes based on other methods of shape correspondence, and/or registration processes that do not rely on fiducial markers (e.g., markerless registration processes). In some embodiments, the registration/alignment process can include features that are generally similar or identical to the registration/alignment processes disclosed in U.S. patent application Ser. No. 16/749,963, titled “ALIGNING PREOPERATIVE SCAN IMAGES TO REAL-TIME OPERATIVE IMAGES FOR A MEDIATED-REALITY VIEW OF A SURGICAL SITE,” filed Jan. 22, 2020, which is incorporated herein by reference in its entirety. In some embodiments, the registration can be carried out using any feature or surface matching registration method, such as iterative closest point (ICP), Coherent Point Drift (CPD), or algorithms based on probability density estimation like Gaussian Mixture Models (GMM). In some embodiments, each of the vertebrae 541 can be registered individually. For example, the first vertebra 541a in the intraoperative image data 540 can be registered to the first vertebra 541a in the initial image data 542 based on corresponding points in both data sets, the second vertebra 541b in the intraoperative image data 540 can be registered to the first vertebra 541b in the initial image data 542 based on corresponding points (e.g., the points 543a-b) in both data sets, and so on. That is, the registration process of block 433 can operate on a per-vertebra basis.

At block 434, the method 430 can include generating one or more transforms for the initial image data based on the registration (block 433). The one or more transforms can be functions that define a mapping between the coordinate system of the initial image data and the coordinate system of the intraoperative image data. At block 435, the registration processing device 105 can include applying the transform to the initial image data in real-time or near-real-time. Applying the transform to the initial image data can substantially align the initial image data with the real-time or near-real-time images of the scene 108 captured with the camera array 110.

Finally, at block 436, the method 430 can include displaying the transformed initial image data and the intraoperative image data together to provide a mediated-reality view of the surgical scene. The view can be provided on the display device 104 to a viewer, such as a surgeon. More specifically, the processing device 102 can overlay the aligned initial image data on the output image of the scene 108 in real-time or near real time on a frame-by-frame basis, even as the virtual perspective changes. That is, the image processing device 103 can overlay the initial image data with the real-time output image of the scene 108 to present a mediated-reality view that enables, for example, a surgeon to simultaneously view a surgical site in the scene 108 and the underlying 3D anatomy of a patient undergoing an operation.

In some embodiments, the position and/or shape of an object within the scene 108 may change over time. For example, the relative positions and orientations of the spine of a patient may change during a surgical procedure as the patient is operated on. Accordingly, the method 430 can include periodically or continuously reregistering the initial image data to the intraoperative image data (e.g., returning from block 436 to block 432) to account for intraoperative movement.

Referring again to FIGS. 5A and 5B, in some instances registering the initial image data 542 to the intraoperative image data 540 based on only two points 543a-b can lead to mis-/ill-registrations in which the points 543a-b are matched correctly but the corresponding vertebrae 541 (e.g., the second vertebra 541b) are not. That is, selecting only two of the points 543a-b can leave the registration problem under constrained. FIG. 5C, for example, illustrates an ill-registration of the initial image data 542 to the intraoperative image data 540 in which the points 543a-b generally match one another correctly but the second vertebra 541b is not accurately registered. Such an ill-registration can cause the display of the initial image data 542 (e.g., as described with reference to block 436 of the method 430 of FIG. 4) to have an implausible pose relative to the intraoperative image data 540 and the physical scene 108. For example, the initial image data 542 of the second vertebra 541b may appear contorted—with the points 543a-b on the second vertebra 541b identified by the surgeon (e.g., using a tracked instrument) having small surface distances between the displayed intraoperative and initial image data 540, 542, at the expense of other regions, such as the spinous process or vertebra body, being grossly misaligned. Although such registration failures are more frequent when using a smaller number of identified regions (e.g., two screw entry points) and may be mitigated by having the surgeon identify more points (e.g., three or more points) using a tracked instrument, requiring the surgeon to identify a large number of points-per-vertebra potentially lengthens the registration procedure and distracts from the surgical workflow.

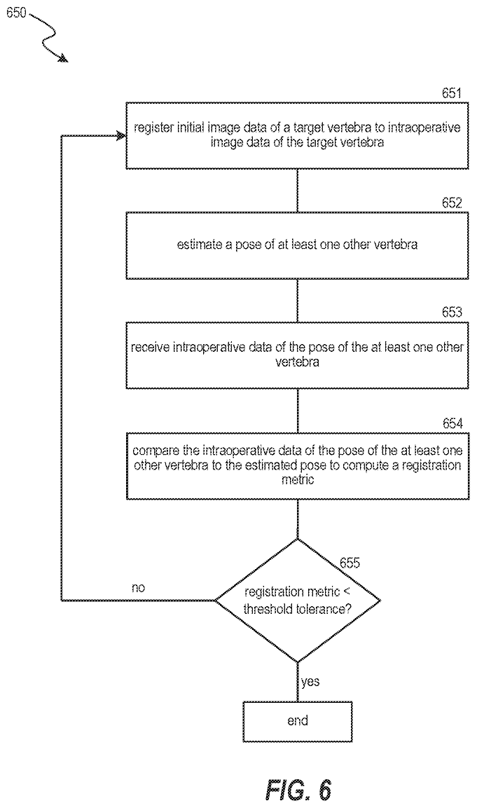

Accordingly, some embodiments of the present technology can utilize additional information captured by the system 100 to reduce the likelihood of ill-registrations without requiring the surgeon or another user to provide additional inputs to the system 100 that may slow or disrupt the surgical workflow. FIG. 6, for example, is a flow diagram of a process or method 650 for registering initial image data to/with intraoperative image data in accordance with embodiments of the present technology. In some embodiments, the method 650 can be used to register the initial image data to the intraoperative image data at block 433 of the method 430 described in detail with reference to FIG. 4. Although some features of the method 430 are described in the context of the system 100 shown in FIGS. 1-3 for the sake of illustration, one skilled in the art will readily understand that the method 650 can be carried out using other suitable systems and/or devices described herein.

At block 651, the method 650 can include registering initial image data of a single target vertebra to intraoperative image data of the target vertebra. In some embodiments, the registration is based on a comparison of common points in both data sets. For example, with reference to FIGS. 5A-5C, the registration can be for the second vertebra 541b based on the commonly identified points 543a-b.

At block 652, the method 650 can include estimating a pose (and/or position) of at least one other vertebra of the spine, such as a vertebra adjacent to the registered target vertebra. For example, with reference to FIGS. 5A-5C together, the initial image data 542 of the first vertebra 541a and/or the third vertebra 541c can be used to estimate the pose of the corresponding physical vertebra in the scene based on the registration of the second vertebra 541b. That is, the initial image data 542 of the first vertebra 541a and/or the third vertebra 541c can be computationally overlaid over the intraoperative image data 540 based on the registration of the target second vertebra 541b. In some embodiments, the estimate of the pose of the at least one other vertebra is a rough estimate because the spine or other object of interest may have deformed or otherwise changed positions between initial imaging and intraoperative imaging (e.g., due to changes of the spine curvature between initial imaging conducted with the patient in a supine position and intraoperative imaging conducted with the patient in a prone position).

At block 653, the method 650 can include receiving intraoperative data of the pose of the at least one other vertebra. For example, the camera array 110 can capture a surface depth map (and/or a 3D surface reconstruction) of the at least one other vertebra based on information from the depth sensor 114. Alternatively, depth or other data can be captured by the cameras 112 and/or other components of the camera array 110.

At block 654, the method 650 can include comparing the captured intraoperative data of the pose of the at least one other vertebra to the estimated pose to compute a registration metric. In some embodiments, computing the registration metric can include computing an objective function value between the intraoperatively determined pose and the pose estimated from the initial registration of the target vertebra. Where the poses of multiple other vertebrae are estimated, the registration metric can be a single (e.g., composite) value or can include individual values for the multiple vertebrae. Accordingly, in some embodiments the registration metric can capture information about the poses of all other (e.g., adjacent) vertebrae of interest.

At decision block 655, the method 650 can include comparing the computed registration metric to a threshold tolerance. If the registration metric is less than the threshold tolerance, the registration is complete and the method 650 ends. For example, referring to FIG. 5B where the registration is generally accurate, the computed registration metric will be relatively small as the estimated pose(s) of either or both of the adjacent first vertebra 541a and the adjacent third vertebra 541c will be similar to the intraoperative data captured about these vertebrae. However, if the registration metric is greater than the threshold tolerance, the registration can return to block 651 to attempt another registration and/or can simply identify the initial registration as an ill-registration. For example, referring to FIG. 5C where the registration is an ill-registration, the computed registration metric will be relatively great as the estimated pose(s) of either or both of the adjacent first vertebra 541a and the adjacent third vertebra 541c will be dissimilar to the intraoperative data captured about these vertebrae. In some embodiments, the system 100 can provide a notification or alert to an operator of the system 100 (e.g., a surgeon, a technician, etc.) that the registration is an ill-registration. In some embodiments, the threshold tolerance can be selected to account for normal differences between the initial and intraoperative data due to temporal changes in the capture of these data sets, as described above.

Accordingly, in some aspects of the present technology the method 650 can reduce the likelihood of ill-registrations like that shown in FIG. 5C. More generally, by propagating the pose of a single, registered, vertebra to its adjacent vertebra the adjacent vertebrae will have poor objective function values in the event of a large registration failure. If the original vertebra is grossly misaligned, then alignments of the adjacent vertebrae should suffer from a lever-arm effect. Incidence of these gross registration failures are therefore reduced by including the objective function values of adjacent vertebrae. However, due to changes of the spine curvature between initial imaging (e.g., typically with the patient in a supine position) and an intraoperative procedure (e.g., typically with the patient in a prone position), the poses of adjacent vertebrae will not be identical. Accordingly, in some embodiments the registration metric can be based on pose comparisons of multiple adjacent vertebrae of interest—allowing the method 650 to simultaneously optimize over all adjacent vertebrae poses of interest. In some aspects of the present technology, this simultaneous optimization (N×6 degrees of freedom, where N=number of vertebrae) creates a rugged optimization function landscape. Because the relative spatial relationship between adjacent vertebrae is generally constrained to a subset of rigid poses with small translation components and limited rotation angles, this optimization function landscape can be searched relatively quickly (e.g., in an intraoperatively compatible timeframe). In some embodiments, such constraints are incorporated as regularization components of the objective function (e.g., block 654) and help “convexify” the registration problem.

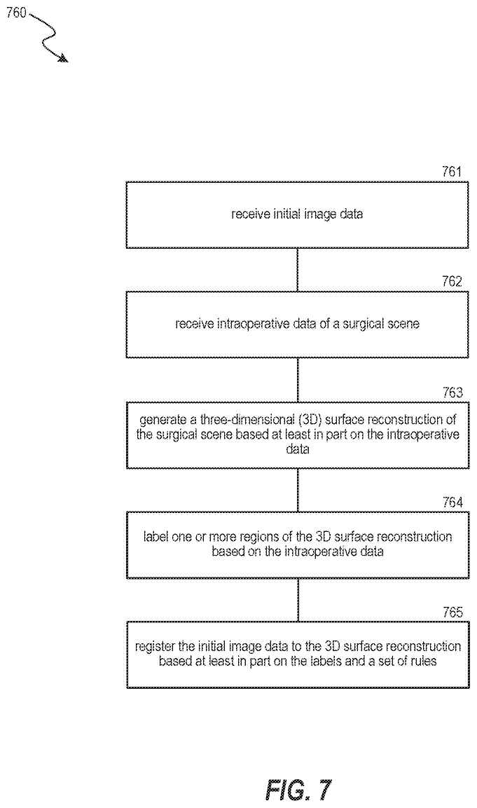

FIG. 7 is a flow diagram of a process or method 760 for registering initial image data to/with intraoperative image data in accordance with additional embodiments of the present technology. In some embodiments, the method 760 can be used to register the initial image data to the intraoperative image data at block 433 of the method 430 described in detail with reference to FIG. 4. Although some features of the method 430 are described in the context of the system 100 shown in FIGS. 1-3 for the sake of illustration, one skilled in the art will readily understand that the method 760 can be carried out using other suitable systems and/or devices described herein.

At block 761, the method 760 can include receiving initial image data. As described in detail above, the initial image data can comprise medical scan data (e.g., preoperative image data) representing a three-dimensional volume of a patient, such as CT scan data. At block 762, the method 760 can include receiving intraoperative data (e.g., image data) of the surgical scene 108 from, for example, the camera array 110. As described in detail above, the intraoperative data can include real-time or near-real-time images from the cameras 112 and/or the depth cameras 118 of the depth sensor 114, such as images of a patient's spine undergoing spinal surgery. In some embodiments, the intraoperative data can include light field data, hyperspectral data, color data, and/or the like from the cameras 112 and images from the depth cameras 118 including encoded depth information.

At block 763, the method 760 can include generating a 3D surface reconstruction of the surgical scene based at least in part on the intraoperative data. The 3D surface reconstruction can include depth information and other information about the scene 108 (e.g., color, texture, spectral characteristics, etc.). That is, the 3D surface reconstruction can comprise a depth map of the scene 108 along with one or more other types of data representative of the scene 108. In some embodiments, the depth information of the 3D surface reconstruction from the intraoperative data can include images of the surgical scene captured with the depth cameras 118 of the depth sensor 114. In some embodiments, the images are stereo images of the scene 108 including depth information from, for example, a pattern projected into/onto the surgical scene by the projector 116. In such embodiments, generating the depth map can include processing the images to generate a point cloud depth map (e.g., a point cloud representing many discrete depth values within the scene 108). For example, the processing device 102 (e.g., the image processing device 103 and/or the registration processing device 105) can process the image data from the depth sensor 114 to estimate a depth for each surface point of the surgical scene relative to a common origin and to generate a point cloud that represents the surface geometry of the surgical scene. In some embodiments, the processing device 102 can utilize a semi-global matching (SGM), semi-global block matching (SGBM), and/or other computer vision or stereovision algorithm to process the image data to generate the point cloud. In some embodiments, the 3D surface reconstruction can alternatively or additionally comprise a 3D mesh generated from the point cloud using, for example a marching cubes or other suitable algorithm. Thus, the 3D surface reconstruction can comprise a point cloud and/or mesh.

At block 764, the method 760 can include labeling/classifying one or more regions of the 3D surface reconstruction based on the intraoperative data. More specifically, the labeling/classifying can be based on information of the scene 108 other than depth. The regions of the 3D surface reconstruction can include individual points of a point cloud depth map, groups of points of a point cloud depth map, vertices of a 3D mesh depth map, groups of vertices of a 3D mesh depth map, and/or the like. The labels can represent different objects/anatomy/substances expected to be in the scene such as, for example: “bone,” “laminar bone,” “transverse process bone,” “tissue,” “soft tissue,” “blood,” “flesh,” “nerve,” “ligament,” “tendon,” “tool,” “instrument,” “dynamic reference frame (DRF) marker,” etc. In some embodiments, block 764 of the method 760 can include analyzing light field image data, hyperspectral image data, and/or the like captured by the cameras 112 to determine one or more characteristics/metrics corresponding to the labels. For example, the registration processing device 105 can analyze light field data, hyperspectral image data, and/or the like from the cameras 112 such as color (e.g., hue, saturation, and/or value), texture, angular information, specular information, and/or the like to assign the different labels to the regions of the 3D surface reconstruction. In some aspects of the present technology, labeling the regions of the 3D surface reconstruction comprises a semantic segmentation of the scene.

In some embodiments, additional information can be used to determine the labels aside from intraoperative data. For example, labels can be determined based on a priori knowledge of a surgical procedure and/or an object of interest in the scene, such as expected physical relationships between different components in the scene. For example, for a spinal surgical procedure, such additional information used to determine the labels can include: (i) the label of a given region of the 3D surface reconstruction should be similar to at least one of the labels of a neighboring region of the 3D surface reconstruction; (ii) the total number of “bone” labels is small compared to the total number of “soft tissue” labels; and/or (iii) regions of the 3D surface reconstruction with “bone” labels should exhibit a constrained rigid relationship corresponding to the constrained relationship between vertebra in the spine.

At block 765, the method 760 can include registering the initial image data to the 3D surface reconstruction based at least in part on the labels and a set of rules (e.g., one or more rules). The rules can be based on apriori knowledge of a surgical procedure or object of interest in the scene. The rules can prohibit or penalize registration solutions that do not follow (e.g., break) the rules—allowing for a more accurate registration solution. For example, for a spinal surgical procedure, rules can include: (i) regions of the 3D surface reconstruction labeled as “soft tissue” should be prohibited from matching or penalized from matching to regions of the initial image data around identified screw entry points because the screw entry points will always be into bone; (ii) regions of the 3D surface reconstruction labeled as “soft tissue” should be allowed to match to regions of the initial image data within a spatial tolerance (e.g., within 2-5 millimeters) of the spinous process of a vertebra within the initial image data because the spinous process is usually not completely exposed during spinal surgery; (iii) some regions of the 3D surface reconstruction labeled as “DRF marker” should be allowed to match to regions of the initial image data showing a target vertebra because the DRF marker is clamped to the target vertebra and thus incident thereon; and/or (iv) regions of the 3D surface reconstruction that match closely to a body of a target vertebra in the initial image data (e.g., the more anterior big rectangular part of the vertebra) should be prohibited from matching or penalized from matching because, in general, the transverse process tips of the vertebra should have a lot of adjacent soft tissue, while the laminar parts should have less.

Registering the initial image data to the 3D surface reconstruction can effectively register all the intraoperative data captured by the camera array 110 to the initial image data. For example, in some embodiments the cameras 112, the trackers 113, the depth sensor 114, and/or other data-capture modalities of the camera array 110 are co-calibrated before use. Accordingly, the registration of the initial image data to the 3D surface reconstruction including, for example, a depth map captured from the depth sensor 114, can be used/extrapolated to register the initial image data to the image data from the cameras 112 and the trackers 113.

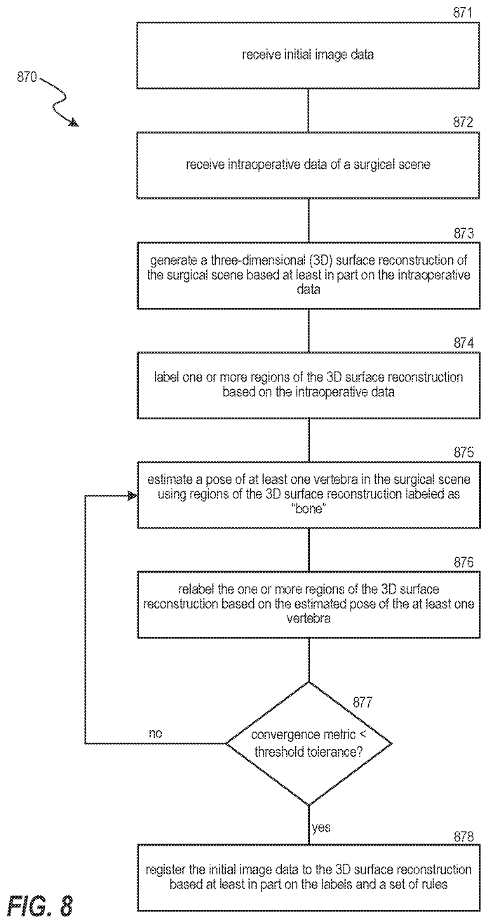

In some embodiments, the labeling of the regions of the 3D surface reconstruction can further be based on an estimated pose of one or more vertebrae or other objects in the scene. That is, many aspects of the methods 650 and 760 can be combined. FIG. 8, for example, is a flow diagram of a process or method 870 for registering initial image data to intraoperative image data in accordance with additional embodiments of the present technology. In some embodiments, the method 870 can be used to register the initial image data to the intraoperative image data at block 433 of the method 430 described in detail with reference to FIG. 4. Although some features of the method 870 are described in the context of the system 100 shown in FIGS. 1-3 for the sake of illustration, one skilled in the art will readily understand that the method 870 can be carried out using other suitable systems and/or devices described herein.

Blocks 871-874 of the method 870 can proceed generally similarly or identically to blocks 761-764, respectively, of the method 760 described in detail with reference to FIG. 7. In some embodiments, at block 874, the method 874 can include labeling the bone of different vertebrae levels separately. For example, a target vertebra for a spinal procedural can be given the label “bone for vertebra i” by identifying the bone substance in the intraoperative data and, for example, identifying that a DRF marker is attached thereto, identifying that more of the target vertebra is exposed than other vertebrae, and/or the like. Then, adjacent vertebrae can be given the labels “bone for vertebra i+1,” “bone for vertebra i−1,” and so on.

At block 875, the method 870 can include estimating a pose of at least one vertebra in the surgical scene using regions of the 3D surface reconstruction labeled as “bone.” For example, the poses of the target vertebra “i” and the adjacent vertebrae “i+1” and “i−1” can be estimated by aligning the initial image data with the regions of the 3D surface reconstruction labeled as “bone” in block 874. At this stage, the initial image data provides an estimated pose of the vertebrae based on the initial labeling of the 3D surface reconstruction.

At block 876, the method 870 includes relabeling the one or more regions of the 3D surface reconstruction based on the estimated pose of the at least one vertebra. For example, regions of the 3D surface reconstruction that fall within the aligned initial image data can be relabeled as “bone” where the initial image data comprises a segmented CT scan.

At decision block 877, the method 870 can include comparing a convergence metric to a threshold tolerance. The convergence metric can provide an indication of how much the labeling has converged toward the estimated poses after an iterative process. If the convergence metric is less than a threshold tolerance (indicating that the labeling has sufficiently converged), the method 870 can continue to block 878 and register the initial image data to the 3D surface reconstruction based at least in part on the labels and a set of rules, as described in detail above with reference to block 765 of the method 760. If the convergence metric is greater than the threshold tolerance (indicating that the labeling has not sufficiently converged), the method 760 can return to block 874 to again estimate the pose of the vertebrae and relabel the regions of the 3D surface reconstruction accordingly.

In this manner, the method 870 can iteratively refine the labeling and vertebrae poses until they sufficiently converge. More specifically, improving the accuracy of the labeling improves the estimated poses of the vertebrae because the poses are based on regions of the 3D surface reconstruction labeled as “bone.” Likewise, the estimated poses introduce additional information from the initial data that can improve the accuracy of the labeling. In some aspects of the present technology, this iterative process can improve the registration accuracy by improving the accuracy of the labels. In some embodiments, the iterative process described in blocks 875-878 of the method 870 can comprise an expectation-maximization (EM) framework and/or can resemble a multiple-body coherent point drift framework.

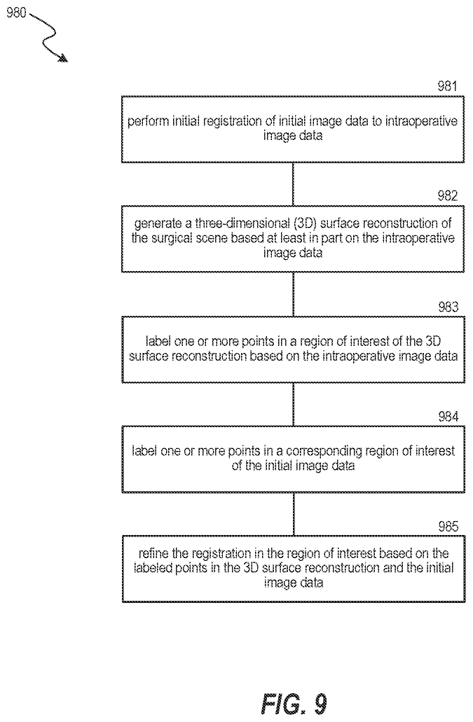

In some embodiments, labeled intraoperative data can be compared to the initial image data to further refine registration accuracy. FIG. 9, for example, is a flow diagram of a process or method 980 for refining the registration of initial image data to intraoperative image data in accordance with embodiments of the present technology. Although some features of the method 980 are described in the context of the system 100 shown in FIGS. 1-3 for the sake of illustration, one skilled in the art will readily understand that the method 980 can be carried out using other suitable systems and/or devices described herein.

At block 981, the method 980 includes performing an initial registration of initial image data to intraoperative image data. The registration can be performed using, for example, any of the methods described in detail above and/or incorporated by reference herein.

Blocks 982 and 983 of the method 980 can proceed generally similarly or identically to blocks 763 and 764, respectively, of the method 760 described in detail with reference to FIG. 7. In some embodiments, at block 983, only points in the 3D surface reconstruction corresponding to a region of interest (e.g., a target vertebra) are labeled.

At block 984, the method 980 can include labeling one or more points in a corresponding region of interest of the initial data. In some embodiments, the labels can represent different objects/anatomy/substances imaged in the initial data such as, for example: “bone,” “laminar bone,” “transverse process bone,” “tissue,” “soft tissue,” “blood,” “flesh,” “nerve,” “ligament,” “tendon,” etc. In some embodiments, the labels are determined by calculating a value for individual pixels or groups of pixels in the region of interest of the initial data. For example, where the initial data is CT data, block 984 can include calculating a Hounsfield unit value for each pixel in the region of interest of the CT data and using the calculated Hounsfield unit value to determine and label a corresponding substance (“bone” or “soft tissue”) in the region of interest.

At block 985, the method 980 includes refining the registration in the region of interest based on the labeled points in the 3D surface reconstruction and the initial data. For example, points having similar labels can be matched together during the refined registration, and/or points with dissimilar labels can be prohibited from matching. Likewise, a set of rules can be used to guide the registration based on the labels, as described in detail above.

In some aspects of the present technology, the ability to differentiate tissue classes, such as epidermis, fat, muscle, and bone can improve the robustness and automation of vertebrae registration strategies. For example, as described in detail above with reference to FIGS. 6-9, intraoperatively differentiating soft tissue from bone when both are surgically exposed from a patient can facilitate vertebrae registration. In some additional embodiments of the present technology, however, a tissue differentiation process may be initiated at the beginning of a surgical procedure before surgical exposure of the anatomy to be registered, updated as the procedure progresses, and ultimately used to improve the registration strategy with respect to robustness and automation.

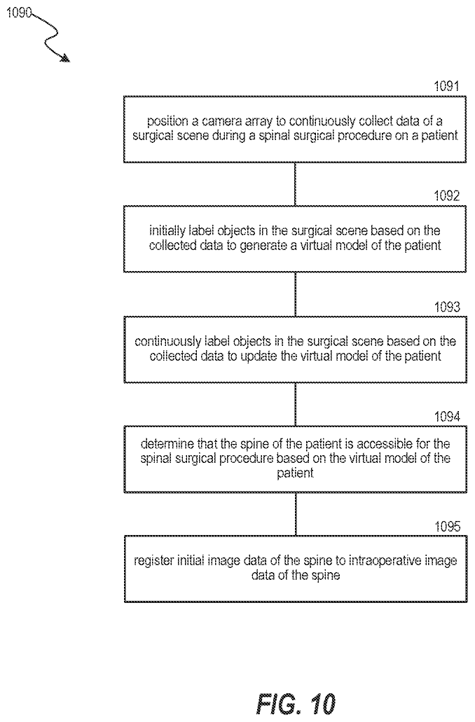

FIG. 10, for example, is a flow diagram of a process or method 1090 for registering initial image data to intraoperative image data in accordance with additional embodiments of the present technology. Although some features of the method 980 are described in the context of the system 100 shown in FIGS. 1-3 for the sake of illustration, one skilled in the art will readily understand that the method 1090 can be carried out using other suitable systems and/or devices described herein. Moreover, although the method 1090 is described in the context of a spinal surgical procedure, the method 1090 can be used other types of surgical procedures.

At block 1091, the method 1090 can include positioning the camera array 110 to continuously collect data during a spinal surgical procedure. The data can include light field data, depth data, color data, texture data, hyperspectral data, and so on. Positioning the camera array 110 can include moving the arm 222 (FIG. 2) to position the camera array 110 above the patient, such as above the back of the patient and the patient's spine.

At block 1092, the method 1090 can include initially labeling objects in the surgical scene based on the data collected from the camera array 110 to generate a virtual model of the patient. The initial labeling can identify, for example, epidermis, surgical adhesives, surgical towels, surgical drapes, and/or other objects present in the scene before the surgical procedure begins. In some embodiments, light field data, color data, RGB data, texture data, hyperspectral data, and/or the like captured by the cameras 112 can be used to differentiate and label the objects. The virtual model therefore provides an overview of the patient and the surrounding scene. The virtual model can comprise not just the surgical site currently visible to the camera array 110, but also a larger portion of the patient as the surgical site is moved. The virtual model can also comprise all or a portion of the scene 108 surrounding the patient that is visible at any point by the camera array 110 and/or other sensors of the system 100 (e.g., sensors mounted in the surgical site).

At block 1093, the method 1090 can include continuously labeling objects in the surgical scene based on the data collected from the camera array 110 to update the virtual model of the patient (and/or all or a portion of the scene 108 surrounding the patient). In some embodiments, the trackers 113 can detect, for example, when a tracked instrument (e.g., the instrument 101, a surgical scalpel) is brought into the scene 108. Likewise, the system 100 (e.g., the processing device 102) can detect when an initial incision is made into the patient by detecting and labeling blood, bone, and/or muscle in the scene 108 based on data (e.g., image data) from the camera array 110.

At block 1094, the method 1090 can determine that the spine of the patient is accessible for a surgical procedure based on the virtual model. For example, the system 100 (e.g., the processing device 102) can detect that some or all of a target vertebra (e.g., labeled as “bone”) is visible to the cameras 112. In an open surgical procedure, the system 100 can detect that some or all of the target vertebra is visible to the cameras 112 in the camera array 110 positioned above the patient while, in a minimally invasive surgical procedure and/or a percutaneous surgical procedure, the system 100 can detect that some or all of the target vertebra is visible to the camera array 110 and/or a percutaneously inserted camera/camera array. In some embodiments, the system 100 can detect that the spine is accessible for the surgical procedure by detecting that a tracked instrument has been removed from the scene 108, replaced with another instrument, and/or inserted into the scene 108. For example, in an open surgical procedure, the system 100 can detect that an instrument for use in exposing the patient's spine has been removed from the scene 108. Similarly, in a minimally invasive surgical procedure, the system 100 can detect that a minimally invasive surgical instrument has been inserted into the scene 108 and/or into the patient.

In some embodiments, determining that the spine of the patient is accessible for the spinal surgical procedure can include determining that the spine is sufficiently exposed by calculating an exposure metric and comparing the exposure metric to a threshold (e.g., similar to blocks 655 and blocks 877 of the methods 650 and 870, respectively, described in detail above). The exposure metric can include, for example, a percentage, value, or other characteristic representing an exposure level of the spine (e.g., as visible to the camera array). If the exposure metric is not met, the method 1090 can continue determining if the spine of the patient is accessible (block 1094) in a continuous manner. When the exposure metric is greater than the threshold, the method 1090 can proceed to block 1095.

At block 1095, the method 1090 can include registering initial image data of the spine to intraoperative image data of the spine after recognizing that surgical exposure is complete or nearly complete (block 1094). That is, the registration can be based on the updated virtual model of the patient which indicates that the spine is sufficiently exposed. The intraoperative image data can comprise images captured by the cameras 112 of the camera array while the initial image data can comprise 3D CT data and/or other types of 3D image data. In some embodiments, the registration can include multiple-vertebrae registrations starting from different initial conditions that are automatically computed. In some embodiments, failed automatic registrations are automatically detected by some processing (e.g., a neural network trained to classify gross registration failures), and the “best” remaining registration is presented to the user. In some aspects of the present technology, by tracking the patient and updating the virtual model of the patient continuously from the beginning of the surgical procedure, the method 1090 can provide an automatic registration technique that does not, for example, require a point-to-point comparison input by the surgeon.

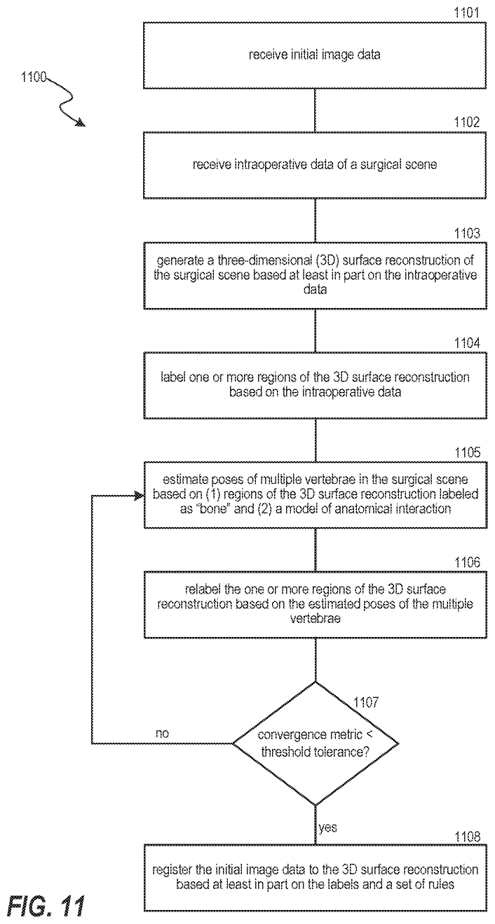

FIG. 11 is a flow diagram of a process or method 1100 for registering initial image data to intraoperative image data in accordance with additional embodiments of the present technology. In some embodiments, the method 1100 can be used to register the initial image data to the intraoperative image data at block 433 of the method 430 described in detail with reference to FIG. 4. Although some features of the method 1100 are described in the context of the system 100 shown in FIGS. 1-3 for the sake of illustration, one skilled in the art will readily understand that the method 1100 can be carried out using other suitable systems and/or devices described herein.

Blocks 1101-1104 of the method 1100 can proceed generally similarly or identically to blocks 761-764, respectively, of the method 760 described in detail with reference to FIG. 7. In some embodiments, at block 1104, the method 1100 can include labeling the bone of different vertebrae levels separately.

At block 1105, the method 1100 can include estimating poses of multiple (e.g., at least two) vertebrae in the surgical scene using (i) regions of the 3D surface reconstruction labeled as “bone” and (ii) a model of anatomical interaction (e.g., a model of spinal interaction). For example, the poses of the two or more vertebrae can be estimated by aligning the initial image data with the regions of the 3D surface reconstruction labeled as “bone” in block 1104. The model of anatomical interaction can comprise one or more constraints/rules on the poses of the multiple vertebrae including, for example, that the vertebrae cannot physically intersect in space, that the vertebrae should not have moved too much relative to each other compared to the initial image data, and so on. Accordingly, the poses can be estimated based on the alignment of the initial image data with the labeled 3D surface reconstruction and as further constrained by the model of anatomical interaction of the spine that inhibits or even prevents pose estimates that are not physically possible or likely. In some aspects of the present technology, the aligned initial image data functions as a regularization tool and the model of anatomical interaction functions to refine the initial image data based on known mechanics of the spine. The multiple vertebrae can be adjacent to one another (e.g., in either direction) or can be non-adjacent to one another. At this stage, the initial image data provides estimated poses of the multiple vertebrae based on the initial labeling of the 3D surface reconstruction and the model of anatomical interaction.

At block 1106, the method 1100 can include relabeling the one or more regions of the 3D surface reconstruction based on the estimated poses of the multiple vertebrae. For example, regions of the 3D surface reconstruction that fall within the aligned initial image data and that agree with the model of anatomical interaction can be relabeled as “bone” where the initial image data comprises a segmented CT scan or other 3D representation of the spine.

Blocks 1107 and 1108 of the method 1100 can proceed generally similarly or identically to blocks 877 and 888, respectively, of the method 870 described in detail with reference to FIG. 8. For example, at decision block 1107, the method 1100 can include comparing a convergence metric to a threshold tolerance. If the convergence metric is less than a threshold tolerance (indicating that the labeling has sufficiently converged), the method 1100 can continue to block 1108 and register the initial image data to the 3D surface reconstruction based at least in part on the labels and a set of rules. If the convergence metric is greater than the threshold tolerance (indicating that the labeling has not sufficiently converged), the method 1100 can return to block 1105 to again estimate the poses of the multiple vertebrae and relabel the regions of the 3D surface reconstruction accordingly.

In this manner, the method 1100 can iteratively refine the labeling and vertebrae poses until they sufficiently converge. More specifically, improving the accuracy of the labeling based on the estimated poses and the model of anatomical interaction improves the estimated poses of the vertebrae because the poses are based on regions of the 3D surface reconstruction labeled as “bone.” Likewise, the estimated poses and the model of anatomical interaction introduce additional information that can improve the accuracy of the labeling. In some aspects of the present technology, the method 1100 provides for multi-level registration in which multiple vertebral levels are registered simultaneously. That is, the registration at block 1108 can register the intraoperative data of the multiple vertebrae to the initial image data of the multiple vertebrae simultaneously rather than by performing multiple successive single-level registrations.

### III. ADDITIONAL EXAMPLES

The following examples are illustrative of several embodiments of the present technology:

1. A method of registering initial image data of a spine of a patient to intraoperative data of the spine, the method comprising:
registering a single target vertebra in the initial image data to the target vertebra in the intraoperative data;
estimating a pose of at least one other vertebra of the spine;
comparing a pose of the at least one other vertebra in the intraoperative data to the estimated pose of the at least one other vertebra to compute a registration metric;
if the registration metric is less than a threshold tolerance, retaining the registration of the target vertebra in the initial image data to the target vertebra in the intraoperative data; and
if the registration metric is greater than the threshold tolerance, identifying the registration of the target vertebra in the initial image data to the target vertebra in the intraoperative data as an ill-registration.

2. The method of example 1 wherein the at least one other vertebra is adjacent to the target vertebra.

3. The method of example 1 or example 2 wherein the intraoperative data comprises intraoperative image data.

4. The method of any one of examples 1-3 wherein the estimated pose is a first estimated pose, wherein the registration metric is a first registration metric, and wherein, if the registration metric is greater than the threshold tolerance, the method further comprises:
reregistering the target vertebra in the initial image data to the target vertebra in the intraoperative data;
estimating a second pose of the at least one other vertebra;
comparing the pose of the at least one other vertebra in the intraoperative data to the estimated second pose of the at least one other vertebra to compute a second registration metric;
if the second registration metric is less than the threshold tolerance, retaining the reregistration of the target vertebra in the initial image data to the target vertebra in the intraoperative data; and
if the second registration metric is greater than the threshold tolerance, identifying the reregistration of the target vertebra in the initial image data to the target vertebra in the intraoperative data as an ill-registration.

5. The method of any one of examples 1-4 wherein, if the registration metric is greater than the threshold tolerance, the method further comprises performing the registering, the estimating, and the comparing until the registration metric is less than the threshold tolerance.

6. The method of any one of examples 1-5 wherein the method further comprises continuously performing the registering, the estimating, and the comparing to continuously register the initial image data to the intraoperative data of the spine during a spinal surgical procedure.

7. The method of any one of examples 1-6 wherein registering the target vertebra in the initial image data to the target vertebra in the intraoperative data is based on commonly identified points in the initial image data and the intraoperative data.

8. The method of example 7 wherein the commonly identified points comprise a number of points such that the registering is under constrained.

9. The method of any one of examples 1-8 wherein the at least one other vertebra comprises a single vertebra.

10. The method of any one of examples 1-8 wherein the at least one other vertebra comprises multiple vertebrae.

11. The method of example 10 wherein the registration metric is a composite value representative of the comparison of the poses of the multiple vertebrae in the intraoperative data to the estimated poses of the multiple vertebrae.

12. The method of any one of examples 1-11 wherein estimating the pose of the at least one other vertebra includes computationally overlaying the initial image data of the at least one other vertebra over the intraoperative data.

13. The method of any one of examples 1-12 wherein the initial image data is medical scan data.

14. An imaging system, comprising:
a camera array including a plurality of cameras configured to capture intraoperative data of a spine of a patient undergoing a spinal surgical procedure; and
a processing device communicatively coupled to the camera array, wherein the processing device is configured to register initial image data of the spine to the intraoperative data of the spine according to the method of any one of examples 1-13.

15. A method of registering initial image data of a patient to intraoperative data of the patient, the method comprising:
generating a 3D surface reconstruction of a portion of the patient based on the intraoperative data;
labeling individual portions of the 3D surface reconstruction with one of multiple labels based on the intraoperative data; and
registering the initial image data to the intraoperative data based at least in part on the labels.

16. The method of example 15 wherein the 3D surface reconstruction includes depth information of the portion of the patient captured by a depth sensor.

17. The method of example 15 or example 16 wherein labeling the individual portions of the 3D surface reconstruction based on the intraoperative data comprises labeling the individual portions of the 3D surface reconstruction with one of the multiple labels based on color information, textural information, spectral information, and/or angular information about the portion of the patient.

18. The method of any one of examples 15-17 wherein the 3D surface reconstruction comprises a point cloud depth map, and wherein labeling the individual portions of the 3D surface reconstruction comprises labeling individual points of the point cloud depth map with one of the multiple labels.

19. The method of any one of examples 15-18 wherein the labels include a first label indicating that a corresponding one of the portions of the 3D surface reconstruction corresponds to bone of the patient, and wherein the labels further include a second label indicating that a corresponding one of the portions of the 3D surface reconstruction corresponds to soft tissue of the patient.

20. The method of example 15-19 wherein registering the initial image data to the intraoperative data is based on the portions of the 3D surface reconstruction having the first label.

21. The method of example 19 or example 20 wherein the portion of the patient is a spine of the patient.

22. The method of any one of examples 15-21 wherein the intraoperative data comprises intraoperative image data.

23. The method of any one of examples 15-22 wherein the method further comprises continuously performing the generating, the labeling, and the registering to continuously register the initial image data to the intraoperative data of the patient.

24. The method of any one of examples 15-23 wherein the initial image data is medical scan data.

25. The method of any one of examples 15-24 wherein registering the initial image data to the intraoperative data is further based on a set of rules.

26. The method of example 25 wherein the rules penalize registration solutions that break the rules.

27. The method of any one of examples 15-26 wherein the labels include a first label indicating that a corresponding one of the portions of the 3D surface reconstruction corresponds to bone of the patient, wherein the portion of the patient includes a single target vertebra and at least one other vertebra of a spine of the patient, and wherein the method further comprises, after labeling the individual portions of the 3D surface reconstruction with one of the multiple labels based on the intraoperative data:
estimating a pose of the at least one other vertebra of the spine;
relabeling the individual portions of the 3D surface reconstruction with one of the multiple labels based on the estimated pose;
computing a convergence metric indicative of a convergence of the relabeling to the estimated pose; and
if the convergence metric is less than a threshold tolerance, registering the initial image data to the intraoperative data based at least in part on the labels; and
if the convergence metric is greater than the threshold tolerance, again performing the estimating, the relabeling, and the computing until the convergence metric is less than the threshold tolerance.

28. The method of any one of examples 15-27 wherein the method further comprises labeling one or more portions of the initial image data with one of the multiple labels, and wherein registering the initial image data to the intraoperative data is further based at least in part on the labels for the initial image data.

29. The method of example 28 wherein the labels for the initial image data include a first label indicating that a corresponding one of the portions of the initial image data corresponds to bone of the patient, and wherein the labels for the initial image data further include a second label indicating that a corresponding one of the portions of the initial image data corresponds to soft tissue of the patient.

30. The method of example 28 or example 29 wherein the initial image data is computed tomography (CT) image data, and wherein labeling the one or more portions of the initial image data comprises calculating a value for individual pixels in the CT image data.

31. The method of example 30 wherein the value is Hounsfield unit value.

32. The method of any one of examples 28-31 wherein registering the initial image data to the intraoperative data comprises matching portions of the 3D surface reconstruction to portions of the initial image data having the same label.

33. An imaging system, comprising:
a camera array including a plurality of cameras configured to capture intraoperative data of a patient; and
a processing device communicatively coupled to the camera array, wherein the processing device is configured to register initial image data of the patient to the intraoperative data according to the method of any of examples 15-32.

34. A method of registering initial image data of a spine of a patient to intraoperative data of the spine, the method comprising:
generating a 3D surface reconstruction of a portion of the patient based on the intraoperative data;
labeling individual portions of the 3D surface reconstruction with one of multiple labels based on the intraoperative data, wherein the labels include a first label indicating that a corresponding one of the portions of the 3D surface reconstruction corresponds to bone of the patient;
estimating poses of multiple vertebrae within the portion of the patient based on (a) regions of the 3D surface reconstruction having the first label and (b) a model of anatomical interaction;
relabeling the individual portions of the 3D surface reconstruction with one of the multiple labels based on the estimated poses;
computing a convergence metric indicative of a convergence of the relabeling to the estimated poses; and
if the convergence metric is less than a threshold tolerance, registering the initial image data to the intraoperative data based at least in part on the labels; and
if the convergence metric is greater than the threshold tolerance, again performing the estimating, the relabeling, and the computing until the convergence metric is less than the threshold tolerance.

35. The method of example 34 wherein the 3D surface reconstruction includes depth information of the portion of the patient captured by a depth sensor.

36. The method of example 34 or example 35 wherein labeling the individual portions of the 3D surface reconstruction based on the intraoperative data comprises labeling the individual portions of the 3D surface reconstruction with one of the multiple labels based on color information, textural information, spectral information, and/or angular information about the portion of the patient.

37. The method of any one of examples 34-36 wherein the 3D surface reconstruction comprises a point cloud depth map, and wherein labeling the individual portions of the 3D surface reconstruction comprises labeling individual points of the point cloud depth map with one of the multiple labels.

38. The method of any one of examples 34-37 wherein the labels further include a second label indicating that a corresponding one of the portions of the 3D surface reconstruction corresponds to soft tissue of the patient.

39. The method of any one of examples 34-38 wherein the intraoperative data comprises intraoperative image data.

40. The method of any one of examples 34-39 wherein the method further comprises continuously performing the generating, the labeling, the estimating, the relabeling, and the computing to continuously register the initial image data to the intraoperative data.

41. The method of any one of examples 34-40 wherein the initial image data is medical scan data.

42. The method of any one of examples 34-41 wherein registering the initial image data to the intraoperative data is further based on a set of rules.

43. The method of any one of examples 34-42 wherein the anatomical model of interaction comprises one or more constraints on the poses of the multiple vertebrae.

44. The method of any one of examples 34-43 wherein the one or more constraints include that the multiple vertebrae cannot physically intersect in space.

45. An imaging system, comprising:
a camera array including a plurality of cameras configured to capture intraoperative data of a spine of a patient undergoing a spinal surgical procedure; and
a processing device communicatively coupled to the camera array, wherein the processing device is configured to register initial image data of the spine to the intraoperative data of the spine according to the method of any one of examples 34-44.

46. A method of registering initial image data of a spine of a patient to intraoperative data of the spine, the method comprising:
positioning a camera array to continuously collect data of a surgical scene during a spinal surgical procedure on the spine of the patient;
initially labeling objects in the surgical scene based on the collected data to generate a virtual model of the patient;
continuously labeling, during the spinal surgical procedure, objects in the surgical scene based on the collected data to update the virtual model of the patient;
determining that the spine of the patient is accessible based on the virtual model; and
registering the initial image data of the spine to intraoperative data of the spine captured by the camera array.

47. The method of example 46 wherein determining that the spine of the patient is accessible comprises calculating an exposure metric and comparing the exposure metric to a threshold.

48. The method of example 47 wherein the exposure metric comprises a value indicating an exposure level of the spine of the patient.

49. The method of any one of examples 46-48 wherein the spinal surgical procedure is an open spinal surgical procedure.

50. The method of any one of examples 46-48 wherein the spinal surgical procedure is a minimally invasive spinal surgical procedure.

51. An imaging system, comprising:
a camera array including a plurality of cameras configured to capture intraoperative data of a spine of a patient undergoing a spinal surgical procedure; and
a processing device communicatively coupled to the camera array, wherein the processing device is configured to register initial image data of the spine to the intraoperative data of the spine according to the method of any one of examples 46-50.

### IV. CONCLUSION

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order, alternative embodiments may perform steps in a different order. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with some embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/We claim:

1. A method of registering initial image data of a spine of a patient to intraoperative data of the spine, the method comprising:
registering a single target vertebra in the initial image data to the target vertebra in the intraoperative data;
estimating a pose of at least one other vertebra of the spine;
comparing a pose of the at least one other vertebra in the intraoperative data to the estimated pose of the at least one other vertebra to compute a registration metric;
if the registration metric is less than a threshold tolerance, retaining the registration of the target vertebra in the initial image data to the target vertebra in the intraoperative data; and
if the registration metric is greater than the threshold tolerance, identifying the registration of the target vertebra in the initial image data to the target vertebra in the intraoperative data as an ill-registration.

2. The method of claim 1 wherein the at least one other vertebra is adjacent to the target vertebra.

3. The method of claim 1 wherein the intraoperative data comprises intraoperative image data.

4. The method of claim 1 wherein the estimated pose is a first estimated pose, wherein the registration metric is a first registration metric, and wherein, if the registration metric is greater than the threshold tolerance, the method further comprises:
reregistering the target vertebra in the initial image data to the target vertebra in the intraoperative data;
estimating a second pose of the at least one other vertebra;
comparing the pose of the at least one other vertebra in the intraoperative data to the estimated second pose of the at least one other vertebra to compute a second registration metric;
if the second registration metric is less than the threshold tolerance, retaining the reregistration of the target vertebra in the initial image data to the target vertebra in the intraoperative data; and
if the second registration metric is greater than the threshold tolerance, identifying the reregistration of the target vertebra in the initial image data to the target vertebra in the intraoperative data as an ill-registration.

5. The method of claim 1 wherein, if the registration metric is greater than the threshold tolerance, the method further comprises performing the registering, the estimating, and the comparing until the registration metric is less than the threshold tolerance.

6. The method of claim 1 wherein the method further comprises continuously performing the registering, the estimating, and the comparing to continuously register the initial image data to the intraoperative data of the spine during a spinal surgical procedure.

7. The method of claim 1 wherein registering the target vertebra in the initial image data to the target vertebra in the intraoperative data is based on commonly identified points in the initial image data and the intraoperative data.

8. The method of claim 7 wherein the commonly identified points comprise a number of points such that the registering is under constrained.

9. The method of claim 1 wherein the at least one other vertebra comprises a single vertebra.

10. The method of claim 1 wherein the at least one other vertebra comprises multiple vertebrae.

11. The method of claim 10 wherein the registration metric is a composite value representative of the comparison of the poses of the multiple vertebrae in the intraoperative data to the estimated poses of the multiple vertebrae.

12. The method of claim 1 wherein estimating the pose of the at least one other vertebra includes computationally overlaying the initial image data of the at least one other vertebra over the intraoperative data.

13. The method of claim 1 wherein the initial image data is medical scan data.

14. A method of registering initial image data of a patient to intraoperative data of the patient, the method comprising:
generating a 3D surface reconstruction of a portion of the patient based on the intraoperative data;
labeling individual portions of the 3D surface reconstruction with one of multiple labels based on the intraoperative data; and
registering the initial image data to the intraoperative data based at least in part on the labels.

15. The method of claim 14 wherein the 3D surface reconstruction includes depth information of the portion of the patient captured by a depth sensor.

16. The method of claim 14 wherein labeling the individual portions of the 3D surface reconstruction based on the intraoperative data comprises labeling the individual portions of the 3D surface reconstruction with one of the multiple labels based on color information, textural information, spectral information, and/or angular information about the portion of the patient.

17. The method of claim 14 wherein the 3D surface reconstruction comprises a point cloud depth map, and wherein labeling the individual portions of the 3D surface reconstruction comprises labeling individual points of the point cloud depth map with one of the multiple labels.

18. The method of claim 14 wherein the labels include a first label indicating that a corresponding one of the portions of the 3D surface reconstruction corresponds to bone of the patient, and wherein the labels further include a second label indicating that a corresponding one of the portions of the 3D surface reconstruction corresponds to soft tissue of the patient.

19. The method of claim 18 wherein registering the initial image data to the intraoperative data is based on the portions of the 3D surface reconstruction having the first label.

20. The method of claim 18 wherein the portion of the patient is a spine of the patient.

21. The method of claim 14 wherein the intraoperative data comprises intraoperative image data.

22. The method of claim 14 wherein the method further comprises continuously performing the generating, the labeling, and the registering to continuously register the initial image data to the intraoperative data of the patient.

23. The method of claim 14 wherein the initial image data is medical scan data.

24. The method of claim 14 wherein registering the initial image data to the intraoperative data is further based on a set of rules.

25. The method of claim 24 wherein the rules penalize registration solutions that break the rules.

26. The method of claim 14 wherein the labels include a first label indicating that a corresponding one of the portions of the 3D surface reconstruction corresponds to bone of the patient, wherein the portion of the patient includes a single target vertebra and at least one other vertebra of a spine of the patient, and wherein the method further comprises, after labeling the individual portions of the 3D surface reconstruction with one of the multiple labels based on the intraoperative data:
estimating a pose of the at least one other vertebra of the spine;
relabeling the individual portions of the 3D surface reconstruction with one of the multiple labels based on the estimated pose;
computing a convergence metric indicative of a convergence of the relabeling to the estimated pose; and
if the convergence metric is less than a threshold tolerance, registering the initial image data to the intraoperative data based at least in part on the labels; and
if the convergence metric is greater than the threshold tolerance, again performing the estimating, the relabeling, and the computing until the convergence metric is less than the threshold tolerance.

27. The method of claim 14 wherein the method further comprises labeling one or more portions of the initial image data with one of the multiple labels, and wherein registering the initial image data to the intraoperative data is further based at least in part on the labels for the initial image data.

28. The method of claim 27 wherein the labels for the initial image data include a first label indicating that a corresponding one of the portions of the initial image data corresponds to bone of the patient, and wherein the labels for the initial image data further include a second label indicating that a corresponding one of the portions of the initial image data corresponds to soft tissue of the patient.

29. The method of claim 27 wherein the initial image data is computed tomography (CT) image data, and wherein labeling the one or more portions of the initial image data comprises calculating a value for individual pixels in the CT image data.

30. The method of claim 29 wherein the value is Hounsfield unit value.

31. The method of claim 27 wherein registering the initial image data to the intraoperative data comprises matching portions of the 3D surface reconstruction to portions of the initial image data having the same label.

32. A method of registering initial image data of a spine of a patient to intraoperative data of the spine, the method comprising:
generating a 3D surface reconstruction of a portion of the patient based on the intraoperative data;
labeling individual portions of the 3D surface reconstruction with one of multiple labels based on the intraoperative data, wherein the labels include a first label indicating that a corresponding one of the portions of the 3D surface reconstruction corresponds to bone of the patient;
estimating poses of multiple vertebrae within the portion of the patient based on (a) regions of the 3D surface reconstruction having the first label and (b) a model of anatomical interaction;
relabeling the individual portions of the 3D surface reconstruction with one of the multiple labels based on the estimated poses;
computing a convergence metric indicative of a convergence of the relabeling to the estimated poses; and
if the convergence metric is less than a threshold tolerance, registering the initial image data to the intraoperative data based at least in part on the labels; and
if the convergence metric is greater than the threshold tolerance, again performing the estimating, the relabeling, and the computing until the convergence metric is less than the threshold tolerance.

33. The method of claim 32 wherein the 3D surface reconstruction includes depth information of the portion of the patient captured by a depth sensor.

34. The method of claim 32 wherein labeling the individual portions of the 3D surface reconstruction based on the intraoperative data comprises labeling the individual portions of the 3D surface reconstruction with one of the multiple labels based on color information, textural information, spectral information, and/or angular information about the portion of the patient.

35. The method of claim 32 wherein the 3D surface reconstruction comprises a point cloud depth map, and wherein labeling the individual portions of the 3D surface reconstruction comprises labeling individual points of the point cloud depth map with one of the multiple labels.

36. The method of claim 32 wherein the labels further include a second label indicating that a corresponding one of the portions of the 3D surface reconstruction corresponds to soft tissue of the patient.

37. The method of claim 32 wherein the intraoperative data comprises intraoperative image data.

38. The method of claim 32 wherein the method further comprises continuously performing the generating, the labeling, the estimating, the relabeling, and the computing to continuously register the initial image data to the intraoperative data.

39. The method of claim 32 wherein the initial image data is medical scan data.

40. The method of claim 32 wherein registering the initial image data to the intraoperative data is further based on a set of rules.

41. The method of claim 32 wherein the anatomical model of interaction comprises one or more constraints on the poses of the multiple vertebrae.

42. The method of claim 32 wherein the one or more constraints include that the multiple vertebrae cannot physically intersect in space.
